(19) United States
(12) Patent Application Publication
(10) Pub. No.: US 2008/0007747 A1
(43) Pub. Date: Jan. 10, 2008

(54) Method and apparatus for model based anisotropic diffusion

(75) Inventors: Troy Chinen, Fremont, CA (US); Thomas Leung, San Jose, CA (US)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/477,942

(22) Filed: Jun. 30, 2006

(51) Int. Cl. G06F 15/00

(52) U.S. Cl. 358/1.9

(57) ABSTRACT

Methods and apparatuses for image processing are presented. An exemplary method is provided which provides a model which includes information not found in the digital image, accessing digital image data and the model, and performing anisotropic diffusion on the digital image data utilizing the model. An apparatus for processing a digital image is presented which includes a processor operably coupled to memory storing digital image data, a model which includes information not found in the digital image data, and functional processing units for controlling image processing, where the functional processing units include a model generation module, and a model-based anisotropic diffusion module which performs anisotropic diffusion on the digital image data utilizing the information provided by the model.

### BACKGROUND OF THE INVENTION

1. Field of the Invention

This invention relates to digital image processing, and more particularly to a method and apparatus for performing anisotropic diffusion processing using a model to provide additional information.

2. Description of the Related Art

Conventional anisotropic diffusion (AD) techniques may be used for edge-preserving noise reduction in digital image data. AD algorithms may remove noise from an image by modifying the image through the application of partial differential equations. This modification typically involves the iterative application of a filtering operator which varies as a function of edge information detected within the image. The location of such edges may be determined utilizing conventional edge detectors such as, for example, those employing gradient functions. In practice, Gaussian filters may provide a reliable way to perform the gradient operations when used conjunction with, for example, a Laplace operator; as well as performing the noise reduction filtering operations.

Implementation of the AD algorithm can be viewed as solving the diffusion differential equation via iterative numerical differential equation solvers, wherein each iteration over the image corresponds to a time step. For each iteration, the scale of a Gaussian filter may be altered, and a gradient function is used to determine whether an edge locally exists within the image. If it is determined that an edge exists, Gaussian filtering may not be performed in order to preserve the edge. If no edge is detected, the area may be filtered to reduce noise. These operations are performed for each iteration, and the local result is combined with the image.

However, one drawback which may be associated with conventional anisotropic diffusion is that the algorithm cannot tell whether an edge is inherent in the structure of an object represented in the image, or whether the edge is caused from some other effect. Such effects could include factors associated with sensing device, environmental conditions during the acquisition of the image (such as, for example, illumination conditions), interactions of objects within the image, etc. What is therefore needed is an anisotropic diffusion approach which can differentiate between edges caused by the object represented in the image and edges due to some other effect.

### SUMMARY OF THE INVENTION

Embodiments consistent with the present invention are directed to methods and apparatuses for model-based anisotropic diffusion which may address issues associated with the prior art. An embodiment is provided which is a method for processing a digital image which includes providing a model which includes information not found in the digital image, accessing digital image data and the model, and performing anisotropic diffusion on the digital image data utilizing the model.

Another embodiment consistent with the invention is an apparatus for processing a digital image, the apparatus may include a processor operably coupled to memory storing digital image data, a model which includes information not found in the digital image data, and functional processing units for controlling image processing, wherein the functional processing units include a model generation module; and a model-based anisotropic diffusion module which performs anisotropic diffusion on the digital image data utilizing the information provided by the model.

Yet another embodiment consistent with the invention is a method for performing model-based anisotropic diffusion which may include modifying the filter kernel size or weighting coefficients used during the anisotropic diffusion, based upon the information provided by the model.

Another embodiment consistent with the invention is a method for performing model-based anisotropic diffusion which may include performing anisotropic diffusion on the digital image data to form a non-model based diffusion image, and performing a linear combination of the digital image data and the non-model based diffusion data, wherein coefficients used in the linear combination are based upon the model.

### BRIEF DESCRIPTION OF THE DRAWINGS

Further aspects and advantages of the present invention will become apparent upon reading the following detailed description taken in conjunction with the accompanying drawings, in which:

FIG. 1 depicts an exemplary flowchart for processing an image using model-based anisotropic diffusion consistent with an embodiment of the present invention;

FIG. 2 shows a more detailed exemplary flowchart for model-based anisotropic diffusion consistent with the embodiment shown in FIG. 1;

FIG. 3 provides another exemplary flowchart for processing an image using model-based anisotropic diffusion consistent with yet another embodiment of the present invention;

FIG. 4 illustrates an exemplary flowchart for model generation consistent with yet another embodiment of the present invention; and

FIG. 5 shows an exemplary apparatus consistent with another embodiment of the present invention.

### DETAILED DESCRIPTION

Aspects of the invention are more specifically set forth in the following description with reference to the appended figures. Although the detailed embodiments described below relate to face recognition or verification, principles of the present invention described herein may also be applied to different object types appearing in digital images.

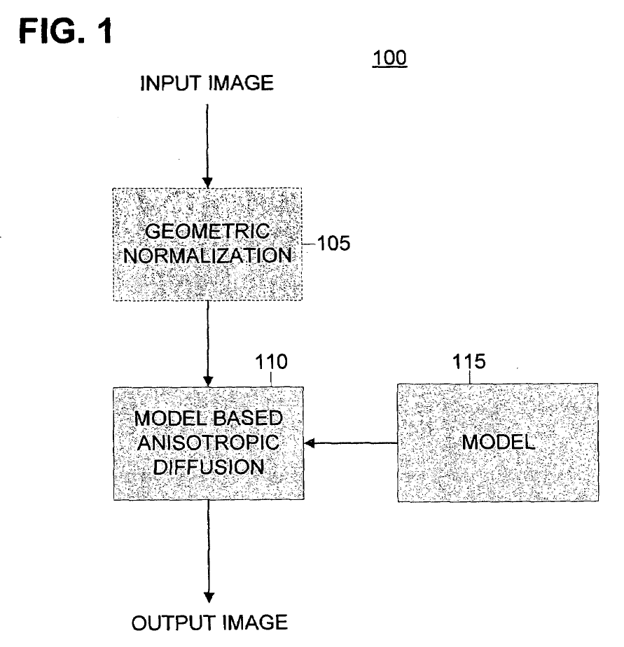

FIG. 1 depicts an exemplary flowchart for an image processing method 100 which uses model-based anisotropic diffusion (MBAD) consistent with an embodiment of the present invention. Image processing method 100 includes optional geometric normalization 105, MBAD 110, and model 115.

An input image is provided which may be a digital image obtained from any known image acquisition device, including, for example, a digital camera, a scanner, etc. The input image may also be an image created through any known synthetic techniques, such as computer generated animation, or may be a combination of digital data which is acquired via a sensor and synthetically generated. The input image may first undergo geometric normalization 105, shown in FIG. 1 using dashed lines to indicate that it is an optional process. Geometric normalization can process the input image so it has a greater degree of compatibility with model 115. Geometric normalization may register the input image with model 115 to improve the overall performance of image processing method 100. The registration may be performed using any registration techniques known in the art, and can further include rotation, scaling, warping, cropping, and/or translation of the of the input image, or any combination thereof. Registration can allow the input image to be transformed into canonical form so that objects represented therein may be associated with representative objects in model 115. As stated above, geometric normalization 105 is optional, and its use may depend upon the object being modeled. For example, if the model was being used to represent the edges of a human face, geometric normalization 105 may typically be performed. However, if the model were being used to assist in the removal of vertical lines within an image, spatial alignment may not have to be performed.

Generally speaking, model 115 may provide any additional information which cannot be determined from the input image itself. Model 115 may be based on any model one of ordinary skill in the art could utilize in order to provide additional information to model-based anisotropic diffusion 110 better remove noise from the input image while minimizing the impact on image features corresponding to real structure.

Model 115 may be based on sensor noise characteristics, whereby if high sensor noise is detected in a region of the model, more filtering may be performed. Model 115 may be based on known geometric-based rules of objects within an image. For example, if an image of a face had dark and light nose halves, a geometric rule could be implemented into model 115 that dictates that noses of people do not have facial features divided in this way, and can this information can be supplied to model based anisotropic diffusion 110 to adjust filtering in this region accordingly. Model 115 may be based upon prior knowledge of controlled lighting which was in place when the image was acquired, and this knowledge may be used to determine the state of edges of the subject in the image. For example, in high illumination areas, one could utilize the knowledge that edges not due to structure in these areas would be minimized in these areas, and model based anisotropic diffusion 110 would vary the filter accordingly.

Model 115 may be based upon texture, and the likelihood that some textures have fewer edges than other textures. This information can be used to alter the filtering parameters in model based anisotropic diffusion 115. Proximity information may also be used to tell model based anisotropic diffusion 110 that various edges may not occur within a certain distance of each other. Markovian models may be used as a statistical approach to provide proximity information. Other models known in the art may also be used to provide such proximity information. Model 115 may also use a priori knowledge of periodic information to assist model based anisotropic diffusion 110. For example, if artifacts such as moiré occur in a particular application, the pattern may be modeled using techniques known in the art to provide information regarding edges to model based anisotropic diffusion 110 which are due to these periodic patterns, so they can be filtered accordingly. One of ordinary skill in the art would appreciate that other known models may be used in model 115 in various other embodiments consistent with the invention.

In one embodiment, model 115 can provide object-based information, and more specifically, information regarding edges within a representative object, which may include the location and likelihood of real edges within the representative object. As used herein, the term “real edges” may be defined as localized contrast variations (i.e. an edge) within an image which solely result from features associated with an object. The real edges typically may not be caused by other effects external to the object, such as environmental phenomena or sensor artifacts. For example, as described in more detail below, if the representative object in model 115 is a face, real edges indicated in the model may be the result of the structural variations in the features naturally occurring in a face, such as, for example, the eyes, nose, mouth, etc. Other representative objects may be generated depending upon what artifacts need to be removed in the input image. For example, predictable structural variations in an imaging device, such as, for example, lens or sensor imperfections, could be characterized in model 115 to assist the noise removal/image enhancement process.

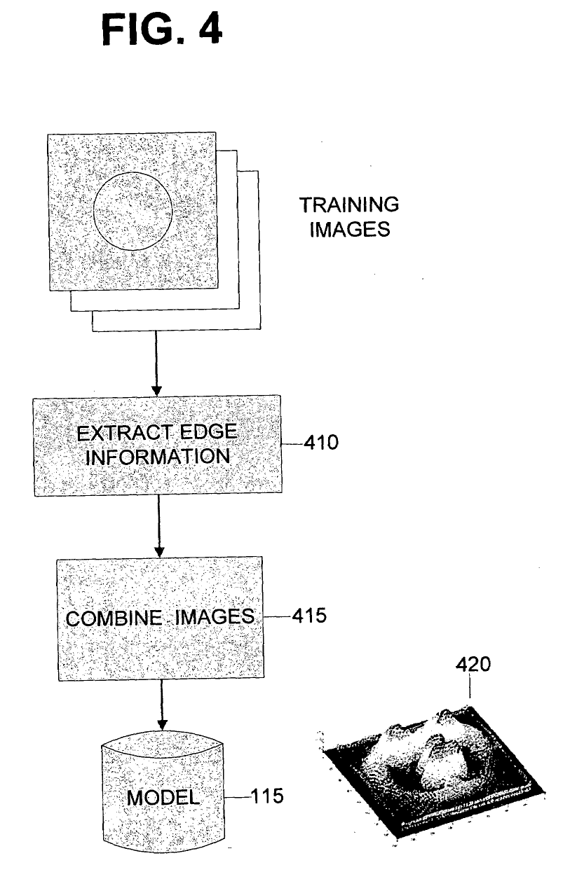

Model 115 may be represented using a variety of different methods. One representation may include a multi-dimensional mathematical function which indicates the probability of an edge as a function of pixel position within the input image. The mathematical function could be determined using regression or other modeling techniques. Model 115 may also be represented by a two-dimensional dataset, having a structure like an image or a surface, where pixel indices in the horizontal and vertical directions represent location, and pixel values represent the probability of a real edge. The values pixel values may take on values between 0 and 1. Details regarding one embodiment for creating a model are presented in further detail below in the description of FIG. 4. Model 115 provides real edge information to model based anisotropic diffusion 110.

Model based anisotropic diffusion 110 may perform the well known anisotropic diffusion process while utilizing real edge information supplied by model 115. While embodiments herein so far have described using anisotropic diffusion, other embodiments of the invention may contemplate other types of diffusion processes, which are known in the art, that could benefit from the information supplied by model 115.

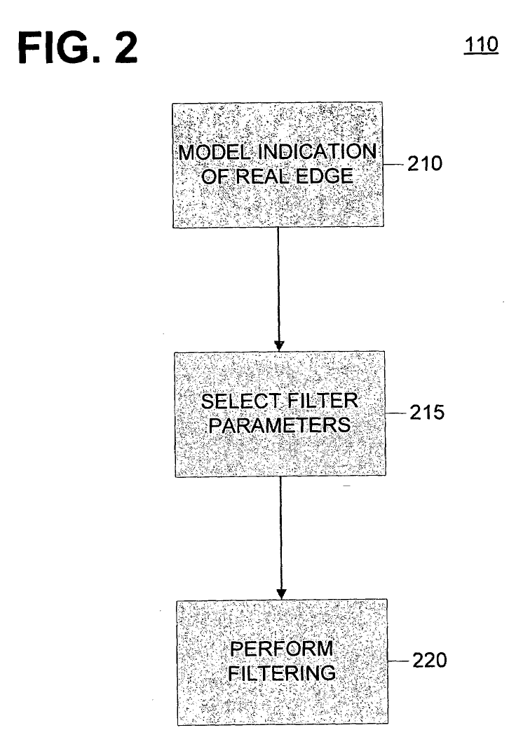

Like standard diffusion algorithms, model based anisotropic diffusion (MBAD) 110 may iteratively perform noise reduction filtering over successive time periods, and use gradient information to determine whether or not an edge exists underneath a filter kernel for a given iteration. However, to improve the edge detection process, MBAD 110 can utilize information from model 115 to determine if an edge underling the filter kernel is a real edge. This information may be utilized during each iteration in the diffusion process, therefore this embodiment of MBAD 110 can modify the internal operations of the algorithm. These modifications can be implemented in a variety of ways. For example, model information 115 may be used to determine whether or not to apply filtering. In another example, model 115 information may be used to alter the filtering parameters, which is described in more detail below in FIG. 2. The output of MBAD 110 may be an enhanced image having noised removed that was present in the input image, while preserving real edge information originally present in the input image of the object.

FIG. 2 shows a more detailed exemplary flowchart for model-based anisotropic diffusion 110 consistent with the embodiment shown in FIG. 1. FIG. 2 details an embodiment of MBAD 110 whereby the filter coefficients are modified on the basis of real edge information provided by model 115. Here, a model 115 provides an indication of a real edge in step 210. On the basis of this information, MBAD. 110 may select filter parameters in step 215. Typically, if a real edge is indicated, less filtering may be performed in order to preserve the edge. If no real edge is indicated, the more filtering may be performed to better reduce noise.

The filter parameters may be selected in a variety of different ways in step 215. In one embodiment, the actual size of the filter kernel could be varied. If the probability of an edge is indicated as high, the size of the filter kernel could be reduced, thus reducing the noise filtering effects. If the probability of a real edge is low, the size of the filter kernel could be increased to better reduce noise. In another embodiment, the values of the filter coefficients themselves may be changed based upon the value of the probability of a real edge. These values could be determined by a look-up table based upon real-edge probabilities, or they could be determined by a mathematical function known to one of ordinary skill in the art. In a simple embodiment, one may adjust the filter parameters so no filtering is performed when the probability of a real edge exceeds a threshold value. Once the filter parameters are determined, the image may be filtered in step 220 using the selected parameters. The filtering may be standard convolutional filtering, or any other filtering known to one of ordinary skill in the art.

The real edge information provided by model 115 may be solely used in selecting filter parameters, or this information may be combined with the gradient edge information typically provided by the anisotropic diffusion process. How these two types of information may be combined may be based upon by the level of confidence in the model of the representative object itself, and/or information regarding the conditions from which the input image was collected.

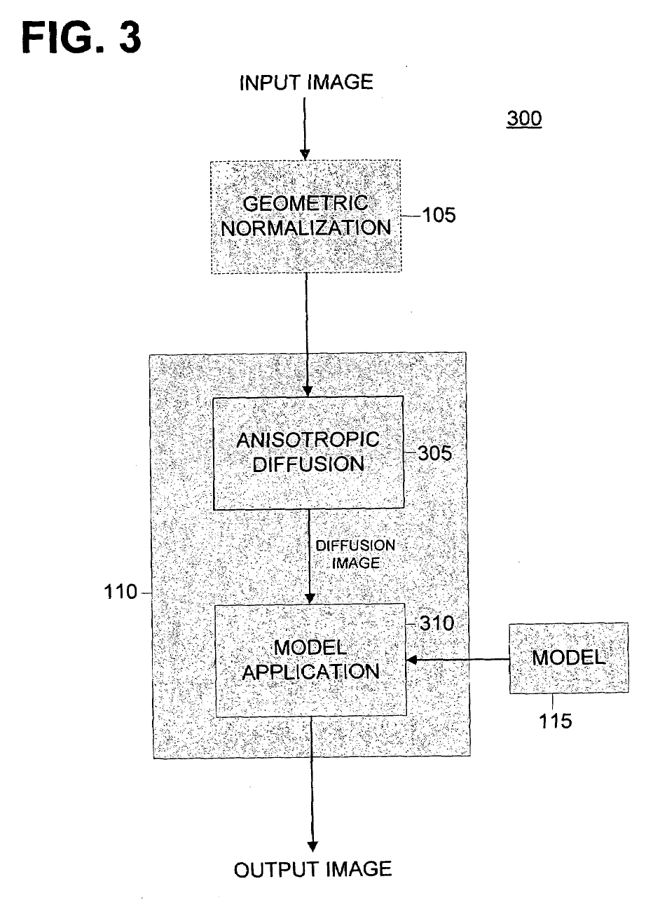

FIG. 3 depicts another exemplary flowchart for an image processing method 300 which uses model-based anisotropic diffusion (MBAD) consistent with another embodiment of the present invention. Image processing method 300 includes optional geometric normalization 105, anisotropic diffusion 305, model 115, and model application 310.

An input image may first undergo an optional geometric normalization step 105, which may be the same process described above in image processing method 100 shown in FIG. 1. This embodiment differs from image processing method 100 in that MBAD 110 is broken down into two components, the first is a conventional anisotropic diffusion process 305, and the second is a model application process 310. This embodiment differs from the embodiment shown in FIG. 1 in that information from the model may not be directly applied during anisotropic diffusion 305, but may be applied after the input image has undergone anisotropic diffusion, for which the result is referred to as a diffusion image. The model information, provided by model 115, is combined with the diffusion image in model application step 310. Model 115 may be the same model discussed above for the embodiment shown in FIG. 1. Anisotropic diffusion 305 may utilize any conventional anisotropic diffusion process known in the art, or for that matter, use any form of known diffusion algorithm.

Model 115 supplies real edge information to model application 310. This information may be combined with the diffusion image and the input image to improve the filtering process. In one embodiment, the diffusion image and the input image may be combined using a simple linear combination, wherein values from model 115 provide weights. The combination may be mathematically described by following equation:

O(x,y)=I(x,y)[1−M(x,y)]+D(x,y)M(x,y)

where
O(x,y): output image;
I(x,y): input image
D(x,y): diffusion image; and
M(x,y): model values.

So for example, in areas of the input image where the edge probability is low, M(x,y) may take on values close to zero. In these areas, output image O(x,y) will be similar to the input image I(x,y).

FIG. 4 illustrates an exemplary flowchart for model generation consistent with yet another embodiment of the present invention. Model 115 may be created by using a set of training images which each contain a representative object of interest. Each training image may be optionally processed with a geometric normalization process similar to the one described above, to ensure each object is a canonical reference (not shown). Next, edge information is extracted from each image in step 410. The edge information may be extracted using any known edge detector, such as, for example, a Sobel edge detector. Once the edge information is extracted from each of the training images, the images may be combined in step 415. The combination may include summing the images together and performing subsequent low pass filtering using a Gaussian kernel. The summing and filtering allows illumination and other variations which occur in each individual training image to be averaged out, reducing “false” edges, and reinforcing real edges corresponding to the representative object. The filtered image may then have a non-linear function applied, such as, for example, a gamma correction, which is known in the art. Further processing may also convert combined image into a probability lying between 0 and 1. The final output is the model 115 which may take the form of a multi-dimensional dataset. In one embodiment, the training images contained faces as the representative object, and created a model providing information relating to real edges within a face. A surface plot 420 of this model is shown in FIG. 4, where peaks can be seen which correspond to facial features. In other embodiments, other meta information could be added to model 115 to improve accuracy. The meta information may include information regarding the sensors which collected the training images, or other information known in the art such as, for example, that there should be no albedo changes on the nose. Other embodiments may allow the model to take the form of a mathematical function instead of a multi-dimensional dataset.

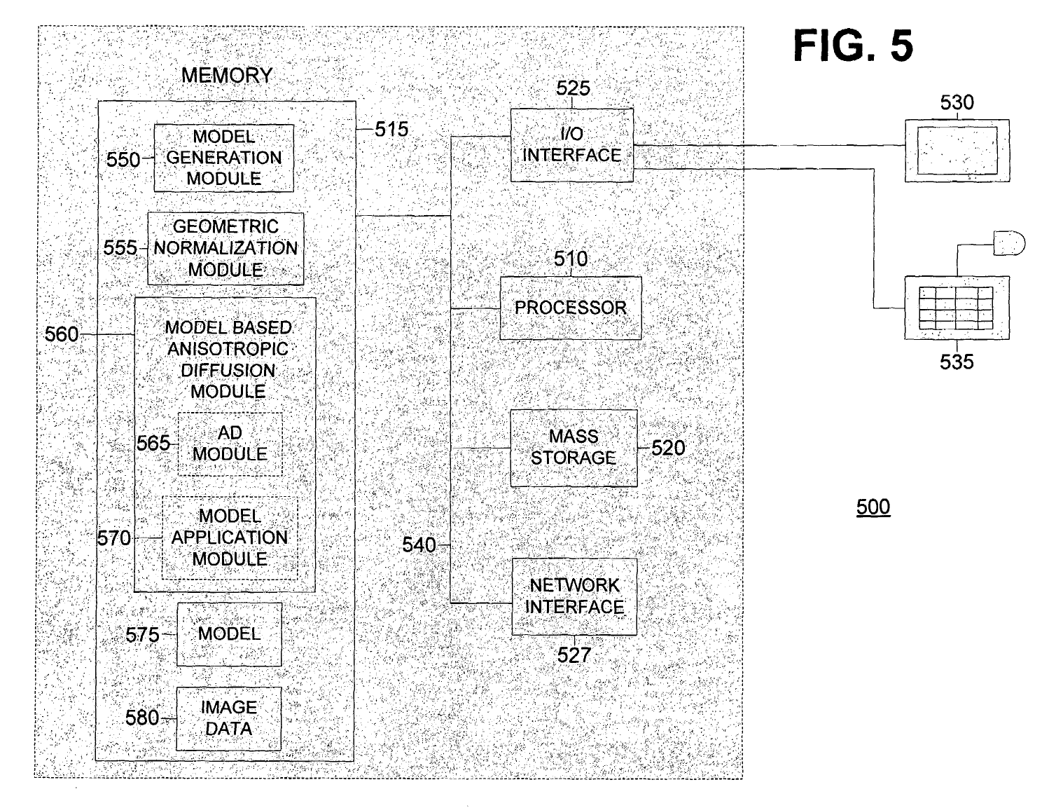

FIG. 5 shows an exemplary processing apparatus 500 consistent with another embodiment of the present invention. Processing apparatus 500 may include at least one processor 510, a memory 515, a mass storage device 520, an I/O interfaces 525, a network interface 527, an output display 530, and a user interface 535. Note that processing apparatus 500 can be any data processing equipment known to one of ordinary skill in the art, such as, for example, workstations, personal computers, special purpose computational hardware, special purpose digital image processors, and/or embedded processors. Processor 510 can execute instructions and perform calculations on image data based upon program instructions. Modules containing executable instructions, and digital image data, can be stored wholly or partially in memory 515, and transferred to processor 510 over a data bus 540. Memory 515 may contain a model generation module 550 to generate model 115, a geometric normalization module 555 to perform optional geometric normalization 105, a model based anisotropic diffusion module 560 to perform MBAD 110 as described in the embodiment shown in FIG. 1. Alternatively, module could contain a conventional anisotropic diffusion model 565 and a model application module 570 which performs the steps shown in the embodiment shown in FIG. 2. Memory 515 may further contain the model module 575 containing the model 115, and image data 580, which could include the input image data, output image data, diffusion image data, and the training image data.

Mass storage 520 can also store program instructions and digital data, and communicate to processor 510 over data bus 540. Processing system can provide and receive other information through I/O interface 525 and network interface 527, to provide information to users on display 530, and receive user commands and/or data through user I/O interface 535.

Although detailed embodiments and implementations of the present invention have been described above, it should be apparent that various modifications are possible without departing from the spirit and scope of the present invention.

We claim:

1. A method for processing a digital image, comprising:
providing a model which includes information not found in the digital image;
accessing digital image data and the model; and
performing anisotropic diffusion on the digital image data utilizing the model.

2. The method according to claim 1, wherein the model includes information at least one of sensor noise characteristics, geometry, intensity levels, texture, proximity, and periodicity.

3. The method according to claim 1, further comprising:
providing a model of a representative object of interest;
predicting edge information regarding the object of interest based upon the model; and
performing anisotropic diffusion on the digital image data utilizing the predicted edge information.

4. The method according to claim 3, further comprising:
modifying filter weighting coefficients used during the performing anisotropic diffusion based upon the edge information provided by the model.

5. The method according to claim 3, further comprising:
modifying the filter kernel size used during the performing anisotropic diffusion based upon the edge information provided by the model.

6. The method according to claims 3, wherein the performing anisotropic diffusion further comprises:
performing anisotropic diffusion on the digital image data to form a non-model based diffusion image; and
performing a linear combination of the digital image data and the non-model based diffusion data, wherein coefficients used in the linear combination are based upon the edge information.

7. The method according to claim 3, further comprising:
generating a model which is based upon a plurality of training images each containing an object of interest.

8. The method according to claim 7, further comprising:
converting each training image into a dataset wherein each value represents a probability of a real edge within the object; and
combining the datasets to form the model.

9. The method according to claim 8, wherein the combining further comprises utilizing information external to the plurality of images.

10. The method according to claim 7, wherein the generating further comprises:
performing an edge detection operation on each image;
registering each edge detected image to a common reference;
generating a composite image by adding, pixel-by-pixel, the registered images; and
normalizing the intensity of the composite image.

11. The method according to claim 3, further comprising:
performing geometric normalization on the digital image data to register the object of interest with the model.

12. The method according to claim 11, wherein the geometric normalization includes at least one of rotating, scaling, warping, and translating.

13. The method according to claim 3, wherein the object of interest is a face.

14. An apparatus for processing a digital image, comprising:
a processor operably coupled to memory storing digital image data, a model which includes information not found in the digital image data, and functional processing units for controlling image processing, wherein the functional processing units comprise:
a model generation module; and
a model-based anisotropic diffusion module which performs anisotropic diffusion on the digital image data utilizing the information provided by the model.

15. The apparatus according to claim 14, wherein the model includes information regarding at least one of sensor noise characteristics, geometry, intensity levels, texture, proximity, and periodicity.

16. The apparatus according to claim 14, wherein the memory stores the model which includes a representative object of interest, the digital image data which contains an object of interest, and further wherein the model-based anisotropic diffusion module predicts edge information regarding the object of interest based upon the model, and performs anisotropic diffusion on the digital image data utilizing the predicted edge information.

17. The apparatus according to claim 16, wherein the model based anisotropic diffusion module modifies filter weighting coefficients based upon the edge information provided by the model.

18. The apparatus according to claim 16, wherein the model based anisotropic diffusion module modifies the filter kernel size based upon the edge information provided by the model.

19. The apparatus according to claims 16, wherein the model-based anisotropic diffusion module further comprises:
an anisotropic diffusion module which performs anisotropic diffusion; and
a model application module which performs a linear combination of the digital image data and anisotropic diffusion data, wherein coefficients used in the linear combination are based upon the edge information.

20. The apparatus according to claim 16, wherein the model generation module generates the model based upon a plurality of training images, each containing an object of interest.

21. The apparatus according to claim 20, wherein the model generation module converts each training image into a dataset wherein each value represents a probability of a real edge within the object, and combines the datasets to form the model.

22. The apparatus according to claim 20, wherein the model generation module utilizes information external to the plurality of training images.

23. The apparatus according to claim 20, wherein the model generation module performs an edge detection operation on each image, registers each edge detected image to a common reference, generates a composite image by adding, pixel-by-pixel, the registered images, and normalizes the intensity of the composite image.

24. The apparatus according to claim 16, further comprising:
a geometric normalization module which performs geometric normalization on the digital image data to register the object of interest with the model.

25. The apparatus according to claim 24, wherein the geometric normalization module performs at least one of rotating, scaling, warping, and translating.

26. The apparatus according to claim 16, wherein the object of interest is a face.

27. A computer readable medium containing executable instructions, wherein the instructions cause a processor to
access a model which includes information not found in a digital image; and
perform anisotropic diffusion on the digital image data utilizing the model.

28. The computer readable medium according to claim 27, wherein the model includes information regarding at least one of sensor noise characteristics, geometry, intensity levels, texture, proximity, and periodicity.

29. The computer readable medium according to claim 27, wherein the instructions flier cause the processor to:
access the model which includes a representative object of interest;
access the digital image data which contains an object of interest;
predict edge information regarding the object of interest based upon the model; and
perform anisotropic diffusion on the digital image data utilizing the predicted edge information.
